(19) United States
(12) Patent Application Publication
(10) Pub. No.: US 2025/0289259 A1
(43) Pub. Date: Sep. 18, 2025

(54) THERMOSENSITIVE RECORDING MEDIUM FOR LINERLESS LABEL

(71) Applicants: Yasufumi Oda, Lawrenceville, GA (US); Kamesh Shah, Lawrenceville, GA (US); Aaron Zahoran, Lawrenceville, GA (US); Toru Kitano, Tokyo (JP)

(72) Inventors: Yasufumi Oda, Lawrenceville, GA (US); Kamesh Shah, Lawrenceville, GA (US); Aaron Zahoran, Lawrenceville, GA (US); Toru Kitano, Tokyo (JP)

(73) Assignee: Ricoh Company, Ltd., Tokyo (JP)

(21) Appl. No.: 19/070,806

(22) Filed: Mar. 5, 2025

Related U.S. Application Data
(60) Provisional application No. 63/566,004, filed on Mar. 15, 2024.

(51) Int. Cl. B41M 5/44

(52) U.S. Cl. CPC B41M 5/443; B41M 2205/32; B41M 2205/40

(57) ABSTRACT

A thermosensitive recording medium for a linerless label is provided. The thermosensitive recording medium includes a support, a thermosensitive recording layer, a protective layer, and a release layer. The release layer includes at least one selected from the group consisting of epichlorohydrin, polyamide epichlorohydrin, an oxazoline derivative, hydrazine, and a hydrazide derivative. The thermosensitive recording layer, the protective layer, and the release layer are disposed on one side of the support.

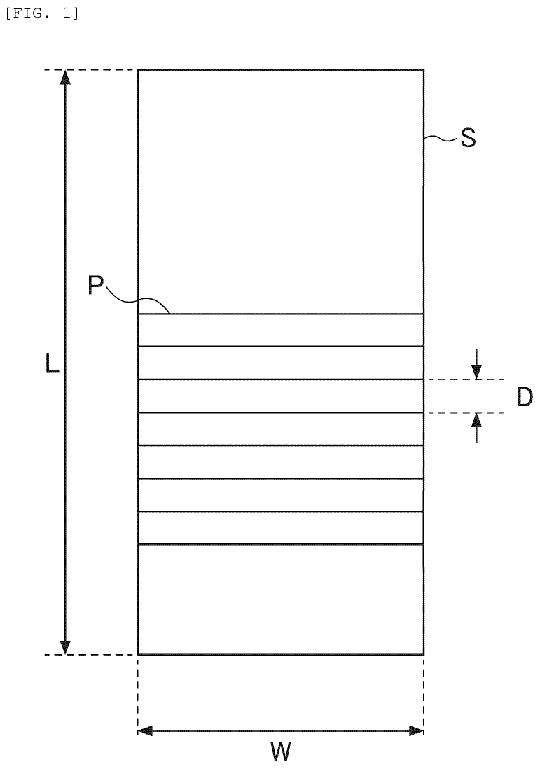

### CROSS-REFERENCE TO RELATED APPLICATIONS

The present application claims priority to U.S. Provisional Patent Application No. 63/566,004, filed on Mar. 15, 2024, at the U.S. Patent and Trademark Office, the entirety of which is incorporated by reference herein.

### TECHNICAL FIELD

The present disclosure relates to thermosensitive recording media for linerless labels.

### BACKGROUND ART

In recent years, there is a demand for linerless labels, which are free of release paper, in view of environmental issues. The application of linerless labels as process control labels for the fast food industry has been increased, in addition to the application as food labels that have been known in the related art. In the above applications, labels using a weakly viscous adhesive or microsphere adhesive are generally used in view of readhesion. In the case where a microsphere adhesive is used, a release coating having a weak release property is ideally provided. Particularly in the application for food products, a non-silicone release agent is preferably used as a release agent in consideration of safety (see, for example, Patent Document 1).

As the quality desired in handling of order labels, resistance of a colored portion against oil or heat is desired. In the case where a non-silicone release agent is simply provided and dried as a top coating on a surface of the label, however, oil resistance is poor compared to UV-curable or thermally crosslinking silicone that has been widely used in the related art. Moreover, a linerless thermosensitive label used as an order label is desired to have high sensitivity so that the thermosensitive label develops a color with low electric power. However, a large deposition amount of the non-silicone release agent is used to form a layer of the non-silicone release agent, and therefore heat applied from a thermal head is not readily transmitted to a thermosensitive recording layer, thereby lowering coloring performance.

### SUMMARY OF INVENTION

### Technical Problem

The present invention has been made in view of the above problems existing in the related art, and aims to provide a thermosensitive recording medium for a linerless label, which has excellent releasability, oil resistance, and printing operability with a printer.

### Solution to Problem

According to one aspect of the present disclosure, a thermosensitive recording medium for a linerless label includes a support, a thermosensitive recording layer, a protective layer, and a release layer. The release layer includes at least one selected from the group consisting of epichlorohydrin, polyamide epichlorohydrin, an oxazoline derivative, hydrazine, and a hydrazide derivative. The thermosensitive recording layer, the protective layer, and the release layer are disposed on one side of the support.

### Advantageous Effects of Invention

According to one aspect of the present disclosure, there can be provided a thermosensitive recording medium for a linerless label, which has excellent releasability, oil resistance, and printing operability with a printer.

### BRIEF DESCRIPTION OF DRAWINGS

### The Figure

The FIGURE is a view illustrating an example of a sample of a thermosensitive recording medium for a linerless label for evaluating properties of the thermosensitive recording medium for the linerless label.

### DESCRIPTION OF EMBODIMENTS

Embodiments of the present disclosure will be described in detail hereinafter. The following embodiments shall not be construed as limiting the scope of the present disclosure, and can be appropriately modified within the spirit of the present disclosure. In the present specification, “to” indicating a numerical range encompasses that the numerical values before and after “to” are included as the lower limit and the upper limit, respectively, unless otherwise specified.

### (Thermosensitive Recording Medium)

The thermosensitive recording medium for the linerless label (may be merely referred to as the “thermosensitive recording medium” hereinafter) according to the present embodiment includes a support, a thermosensitive recording layer, a protective layer, and a release layer, where the thermosensitive recording layer, the protective layer, and the release layer are disposed on one side of the support. In the present specification, the thermosensitive recording layer may be referred to as a thermosensitive layer. The thermosensitive recording medium of the present embodiment includes the support, and the thermosensitive recording layer, the protective layer, and the release layer, which are disposed on the support in the order as mentioned. The thermosensitive recording medium of the present embodiment may further include other layers as necessary.

In the present specification, “on the support” means on at least one side of the support, and generally means one of the planes. In addition, the phrase “disposed on the support” is not limiting as long as corresponding layers are present directly or indirectly on at least part of the support.

The present inventors have conducted intensive studies focusing on the difficulty in simultaneously achieving oil resistance, releasability, and printing operability with a printer, in the case where a release layer is disposed on a protective layer. As a result, the present inventors have found that oil resistance, releasability, and printing operability with a printer are simultaneously improved when the release layer includes at least one selected from the group consisting of epichlorohydrin, polyamide epichlorohydrin, an oxazoline derivative, hydrazine, and a hydrazide derivative.

### <Release Layer>

The release layer has a release function against an adhesive of a linerless label. The release layer is disposed on the protective layer. Specifically, the release layer constitutes the outermost surface layer of the thermosensitive recording medium.

A printer matching function, which is a function of conforming to a thermosensitive printer, is generally imparted to the below-described protective layer, not to the release layer. Thus, it is desired to utilize the printer matching function of the protective layer. To this end, sufficient adhesion between the protective layer and the release layer is desired. By enhancing the adhesion between the protective layer and the release layer, the printer matching function of the protective layer can be more effectively exhibited even if the protective layer is not present at the outermost surface of the thermosensitive recording medium.

As a material of the release layer, for example, a release agent can be used. Examples of the release agent used in the release layer include UV-curable silicone release agents, heat-curable silicone release agents, solvent-free silicone release agents, solvent-based silicone release agents, emulsion-based silicone release agents, fluorine-based release agents, and the like.

Moreover, as a recent trend, use of a microsphere adhesive as an adhesive of process control labels is becoming more and more popular. It is therefore possible to provide a label, which can be cleanly peeled off after adhering once, and can be repeatedly readhered many times when the label is used for process control in a fast food store or the like. In the case where a microsphere adhesive is used in a linerless label, the above silicone-based release agent has an excessively high release property such that the adhesive is unintentionally peeled off from the release layer.

For a linerless label for process control, which uses a microsphere adhesive, a non-silicone-based releasing agent having a slightly lower release function than a silicone-based release agent is preferably used in a release layer. Examples of the non-silicone material include long-chain alkyl acrylates, silicone-modified acrylics, vinyl acetate-modified silicone, and the like. Among the above examples, long-chain alkyl acrylates and silicone-modified acrylics are more preferably used. The above examples may be used alone or in combination.

The release layer includes, as a crosslinking agent, at least one selected from the group consisting of epichlorohydrin, polyamide epichlorohydrin, an oxazoline derivative, hydrazine, and a hydrazide derivative. Since the above crosslinking agent is included in the release layer, the crosslinking agent forms crosslinks with a resin of the below-described protective layer to enhance the adhesion between the release layer and the protective layer. Thus, the protective layer can more effectively exhibit the printer matching function, thereby increasing stickiness.

An amount of the crosslinking agent is not particularly limited. For example, the amount of the crosslinking agent is from 0.05 percent by mass to 20 percent by mass, and more preferably from 0.1 percent by mass to 10 percent by mass, relative to 100 percent by mass of a total mass of the release layer.

The release layer preferably further includes polyvinyl alcohol that is crosslinkable with the crosslinking agent. The polyvinyl alcohol is a resin that can be also used as a resin of the below-described protective layer. Since the release layer includes the resin that is the same as the resin of the protective layer, the adhesion between the release layer and the protective layer is enhanced so that improvement in printing operability with a printer can be expected.

In addition, the polyvinyl alcohol in the protective layer functions as a barrier resin against an oil or the like. Since the polyvinyl alcohol is included in the release layer, improvement in preservation of oil resistance can be expected. Further, addition of the polyvinyl alcohol can adjust a fluidity of a release liquid for forming a release layer so that the release liquid can be applied by curtain coating, or rod or bar coating.

Examples of the polyvinyl alcohol crosslinkable with the crosslinking agent include carboxyl group-containing modified polyvinyl alcohol, carbonyl group-containing modified polyvinyl alcohol, and the like.

An amount of the polyvinyl alcohol in the release layer is preferably from 0.5 percent by mass to 30 percent by mass, more preferably from 0.8 percent by mass to 23 percent by mass, and yet more preferably from 1 percent by mass to 25 percent by mass, relative to 100 percent by mass of a total mass of the release layer. Since the amount of the polyvinyl alcohol in the release layer is within the above range, reduction in the adhesion between the release layer and protective layer can be avoided while maintaining releasability of the release layer.

A degree of polymerization of the polyvinyl alcohol in the release layer is preferably from 200 to 2,500, more preferably from 220 to 2, 300, and yet more preferably from 240 to 2,100. Since the degree of polymerization of the polyvinyl alcohol in the release layer is within the above range, the fluidity of the release liquid for forming the release layer can be adjusted so that the release layer can be applied by curtain coating, or rod or bar coating release layer.

A coating method for the release liquid for forming the release layer is not particularly limited, and may be appropriately selected according to the intended purpose. Examples of the coating method include blade coating, gravure coating, gravure offset coating, bar coating, roll coating, knife coating, air-knife coating, comma coating, U-comma coating, AKKU coating, smoothing coating, microgravure coating, reverse roll coating, 4-roll or 5-roll coating, dip coating, single layer curtain coating, simultaneous multilayer curtain coating, slide coating, die coating, and the like. Among the above examples, simultaneous multilayer curtain coating is preferably used because the release layer can be formed simultaneously with the thermosensitive recording layer and the protective layer on the support.

For the production of the thermosensitive recording medium according to the present embodiment, a method of simultaneously coating a support with a thermosensitive layer, a protective layer, a release layer, and other layers by simultaneous multilayer curtain coating to form coating layers is particularly preferably used in view of cost efficiency, improvement in uniformity of the coating layers, and improvement in printer matching (conformability with a printer) due to improved adhesion between the protective layer and the release layer.

An average thickness of the release layer is not particularly limited, and may be appropriately selected according to the intended purpose. The average thickness of the release layer is preferably from 0.2 μm to 5 μm, more preferably from 0.3 μm to 4 μm, and yet more preferably from 0.5 μm to 3 μm.

### <Protective Layer>

The protective layer has a function of protecting the thermosensitive recording layer. The protective layer is disposed directly or indirectly on the thermosensitive recording layer. The protective layer includes a binder resin and a crosslinking agent, and may further include other components, as necessary.

### «Binder Resin»

The binder resin included in the protective layer is not particularly limited, and may be appropriately selected according to the intended purpose. Examples of the binder resin include water-soluble resins, water-soluble resin emulsions, hydrophobic resins, UV-curable resins, electron beam-curable resins, and the like.

Examples of the water-soluble resins include polyvinyl alcohol, modified polyvinyl alcohol, starch or starch derivatives, cellulose derivatives (e.g., methoxy cellulose, hydroxyethyl cellulose, carboxymethyl cellulose, methyl cellulose, and ethyl cellulose), sodium polyacrylate, polyvinyl pyrrolidone, acrylamide-acrylate copolymers, acrylamide-acrylate-methacrylic acid terpolymers, alkaline salts of styrene-maleic anhydride copolymers, alkaline salts of isobutylene-maleic anhydride copolymers, polyacrylamide, modified polyacrylamide, methyl vinyl ether-maleic anhydride copolymers, carboxy-modified polyethylene, polyvinyl alcohol-acrylamide block copolymers, melamine-formaldehyde resins, urea-formaldehyde resins, sodium alginate, gelatin, casein, and the like. The above examples may be used alone or in combination. Among the above examples, polyvinyl alcohol crosslinkable with a crosslinking agent is preferably used, and modified polyvinyl alcohol is more preferably used. The polyvinyl alcohol crosslinkable with the crosslinking agent may be the same resin as the polyvinyl alcohol in the release layer.

Examples of the modified polyvinyl alcohol include: diacetone-modified polyvinyl alcohol; acetoacetyl-modified polyvinyl alcohol; carboxylic acid-modified polyvinyl alcohol, such as itaconic acid-modified polyvinyl alcohol and maleic acid-modified polyvinyl alcohol; carbonyl group-containing modified polyvinyl alcohol; and the like.

### «Crosslinking Agent»

The crosslinking agent is not particularly limited, as long as the crosslinking agent reacts with the water-soluble resin, thereby lowering solubility of the water-soluble resin in water. The crosslinking agent may be appropriately selected according to the intended purpose. Examples of the crosslinking agent include glyoxal derivatives, methylol derivatives, epichlorohydrin, polyamide epichlorohydrin, epoxy compounds, adirizine compounds, hydrazine, hydrazide derivatives, oxazoline derivatives, carbodiimide derivatives, and the like. The above examples may be used alone or in combination. Among the above examples, polyamide epichlorohydrin is particularly preferably used because of high safety during handling and a short curing time for achieving water resistance.

An amount of the crosslinking agent is not particularly limited. For example, the amount of the crosslinking agent is from 10 percent by mass to 60 percent by mass, and preferably from 20 percent by mass to 50 percent by mass, relative to 100 percent by mass of the binder resin.

As components included in the protective layer other than the binder resin and the crosslinking agent, the protective layer may include a pigment (filler), auxiliary additives, and the like.

Examples of the pigment include: inorganic pigments, such as zinc oxide, calcium carbonate, barium sulfate, titanium oxide, lithopone, talc, pagodite, kaolin, aluminum hydroxide, and calcined kaolin; organic pigments, such as crosslinked polystyrene resins, urea resins, silicone resins, crosslinked methyl polymethacrylate resins, and melamine-formaldehyde resins; and the like.

Examples of the auxiliary additives include surfactants, thermoplastic materials, lubricants, pressure-induced color-development inhibitors, and the like.

A production method for the protective layer is not particularly limited, and any coating method in the related art can be used. Examples of the coating method include blade coating, gravure coating, gravure offset coating, bar coating, roll coating, knife coating, air-knife coating, comma coating, U-comma coating, AKKU coating, smoothing coating, microgravure coating, reverse roll coating, 4-roll or 5-roll coating, dip coating, single layer curtain coating, simultaneous multilayer curtain coating, slide coating, die coating, and the like. Among the above examples, simultaneous multilayer curtain coating is preferably used because the protective layer can be formed simultaneously with the release layer and the thermosensitive recording layer on the support.

An average thickness of the protective layer is not particularly limited, and may be appropriately selected according to the intended purpose. The average thickness of the protective layer is preferably from 0.5 μm to 5 μm, and more preferably from 1 μm to 3 μm.

### <Thermosensitive Recording Layer>

The thermosensitive recording layer has a function of developing a color upon application of heat. The thermosensitive recording layer is disposed directly or indirectly on the support. The thermosensitive recording layer preferably includes a leuco dye and a color developer, and may further include other components, as necessary.

### «Leuco Dye»

The leuco dye is not particularly limited, and may be appropriately selected from leuco dyes used for general thermosensitive recording media according to the intended purpose. Examples of the leuco dye suitably include dyes of leuco compounds, such as triphenylmethane-based compounds, fluoran-based compounds, phenothiazine-based compounds, auramine-based compounds, spiropyran-based compounds, and indolino-phthalide-based compounds.

Specific examples of the leuco compounds include 3,3-bis(p-dimethylaminophenyl)-phthalide, 3,3-bis(p-dimethylaminophenyl)-6-dimethylaminophthalide (synonym: crystal violet lactone), 3,3-bis(p-dimethylaminophenyl)-6-diethylaminophthalide, 3,3-bis(p-dimethylaminophenyl)-6-chlorophthalide, 3,3-bis(p-dibutylaminophenyl)phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzofluoran, 3-diethylamino-6-methyl-7-chlorofluoran, 3-(N-p-tolyl-N-ethylamino)-6-methyl-7-anilinofluoran, 2-{N-(3′-trifluoromethylphenyl)amino}-6-diethylaminofluoran, 2-{3,6-bis(diethylamino)-9-(o-chloroanilino)xanthyl benzoic acid lactam}, 3-diethylamino-6-methyl-7-(m-trichloromethylanilino)fluoran, 3-diethylamino-7-(o-chloroanilino)fluoran, 3-pyrrolidino-6-methyl-7-anilinofluoran, 3-di-n-butylamino-7-o-chloroanilino)fluoran, 3-N-methyl-N, n-amylamino-6-methyl-7-anilinofluoran, 3-N-methyl-N-cyclohexylamino-6-methyl-7-anilinofluoran, 3-diethylamino-6-methyl-7-anilinofluoran, 3-(N,N-diethylamino)-5-methyl-7-(N,N-dibenzylamino)fluoran, benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′-chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chloro-5′-methylphenyl)phthalide, 3-(N-ethyl-N-tetrahydrofurfuryl)amino-6-methyl-7-anilinofluoran, 3-N-ethyl-N-(2-ethoxypropyl)amino-6-methyl-7-anilinofluoran, 3-N-methyl-N-isobutyl-6-methyl-7-anilinofluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-di-n-butylamino-6-methyl-7-anilinofluoran, 3,6-bis(dimethylamino)fluorene spiro (9,3′)-6′-dimethylaminophthalide, 3-(N-benzyl-N-cyclohexylamino)-5,6-benzo-7-α-napthylamino-4′-boromofluoran, 3-diethylamino-6-chloro-7-anilinofluoran, 3-diethylamino-6-methyl-7-mesitydino-4′,5′-benzofluoran, 3-N-methyl-N-isopropyl-6-methyl-7-anilinofluoran, 3-N-ethyl-N-isoamyl-6-methyl-7-anilinofluoran, 3-diethylamino-6-methyl-7-(2′,4′-dimethylanilino)fluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-N-butylanilino)fluoran, 3,6-bis(dimethylamino)fluorene spiro(9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-N-ethyl-N—(-2-ethoxypropyl)amino-6-methyl-7-anilinofluoran, 3-N-ethyl-N-tetrahydrofurfurylamino-6-methyl-7-anilinofluoran, 3-(p-dimethylaminophenyl)-3-{1,1-bis(p-dimethylaminophenyl)ethylen-2-yl}phthalide, 3-(p-dimethylaminophenyl)-3-{1,1-bis(p-dimethylaminophenyl)ethylen-2-yl}-6-dimethylaminophthalide, 3-(p-dimethylaminophenyl)-3-(1-p-dimethylaminophenyl-1-phenylethylen-2-yl)phthalide, 3-(p-dimethylaminophenyl)-3-(1-p-dimethylaminophenyl-1-p-chlorophenylethylen-2-yl)-6-dimethylaminophthalide, 3-(4′-dimethylamino-2′-methoxy)-3-(1″-p-dimethylaminophenyl-1″-p-chlorophenyl-1″,3″-butadien-4″-yl)benzophthalide, 3-(4′-dimethylamino-2′-benzyloxy)-3-(1″-p-dimethylaminophenyl-1″-phenyl-1″,3″-butadien-4″-yl)benzophthalide, 3-dimethylamino-6-dimethylamino-fluorene-9-spiro-3′-(6′-dimethylamino)phthalide, 3,3-bis(2-(p-dimethylaminophenyl)-2-p-methoxyphenyl)etenyl)-4, 5, 6, 7-tetrachlorophthalide, 3-bis {1,1-bis(4-pyrrolidinophenyl)ethylen-2-yl}-5,6-dichloro-4,7-dibromophthalide, bis(p-dimethylaminostyryl)-1-naphthalenesulfonylmethane, bis(p-dimethylaminostyryl)-1-p-tolylsulfonylmethane, and the like. The above examples may be used alone or in combination.

An amount of the leuco dye is not particularly limited. For example, the amount of the leuco dye is from 3 percent by mass to 30 percent by mass relative to 100 percent by mass of a total mass of the thermosensitive recording layer.

### «Color Developer»

As the color developer, various electron-accepting compounds that cause leuco dyes to color when heated may be used. Examples of the color developer include phenolic compounds, organic or inorganic acidic compounds, esters of the foregoing, salts of the foregoing, and the like.

Specific examples of the color developer include gallic acid, salicylic acid, 3-isopropylsalicylic acid, 3-cyclohexylsalicylic acid, 3,5-di-t-butylsalicylic acid, 3,5-di-α-methylbenzylsalicylic acid, 4,4′-isopropylidenediphenol, 1,1′-isopropylidenebis(2-chlorophenol), 4,4′-isopropylidenebis(2,6-dibromophenol), 4,4′-isopropylidenebis(2,6-dichlorophenol), 4,4′-isopropylidenebis(2-methylphenol), 4,4′-isopropylidenebis(2,6-dimethylphenol), 4,4′-isopropylidenebis(2-t-butylphenol), 4,4′-s-butylidenebisiphenol, 4,4′-cyclohexylidenebisphenol, 4,4′-cyclohexylidenebis(2-methylphenol), 4-t-butylphenol, 4-phenylphenol, 4-hydroxydiphenoxide, α-naphthol, β-naphthol, 3,5-xylenol, thymol, methyl-4-hydroxybenzoate, 4-hydroxyacetophenone, novolac phenolic resins, 2,2′-thiobis(4,6-dichlorophenol), catechol, resorcin, hydroquinone, pyrogallol, phloroglycinol, phloroglucinol carboxylic acid, 4-t-octylcatechol, 2,2′-methylenebis(4-chlorophenol), 2,2′-methylenebis(4-methyl-6-t-butylphenol), 2,2′-dihydroxydiphenyl, ethyl p-hydroxybenzoate, propyl p-hydroxybenzoate, butyl p-hydroxybenzoate, benzyl p-hydroxybenzoate, p-hydroxybenzoic acid-p-chlorobenzyl, p-hydroxybenzoic acid-o-chlorobenzyl, p-hydroxybenzoic acid-p-methylbenzyl, p-hydroxybenzoic acid-n-octyl, benzoic acid, zinc salicylate, 1-hydroxy-2-naphthoic acid, 2-hydroxy-6-naphthoic acid, zinc 2-hydroxy-6-naphthoate, 4-hydroxydiphenylsulfone, 4-hydroxy-4′-chlorodiphenylsulfone, bis(4-hydroxyphenyl) sulfide, 2-hydroxy-p-toluic acid, zinc 3,5-di-t-butylsalicylate, tin 3,5-di-t-butylsalicylate, tartaric acid, oxalic acid, maleic acid, citric acid, succinic acid, stearic acid, 4-hydroxyphthalic acid, boric acid, thiourea derivatives, 4-hydroxythiophenol derivatives, bis(4-hydroxyphenyl) acetic acid, ethyl bis(4-hydroxyphenyl)acetate, n-propyl bis(4-hydroxyphenyl)acetate, n-butyl bis(4-hydroxyphenyl)acetate, phenyl bis(4-hydroxyphenyl)acetate, benzyl bis(4-hydroxyphenyl)acetate, phenethyl bis(4-hydroxyphenyl)acetate, bis(3-methyl-4-hydroxyphenyl) acetic acid, methyl bis(3-methyl-4-hydroxyphenyl)acetate, n-propyl bis(3-methyl-4-hydroxyphenyl)acetate, 1,7-bis(4-hydroxyphenylthio)-3,5-dioxaheptane, 1,5-bis(4-hydroxyphenylthio)-3-oxapenthane, dimethyl 4-hydroxyphthalate, 4-hydroxy-4′-methoxydiphenylsulfone, 4-hydroxy-4′-ethoxydiphenylsulfone, 4-hydroxy-4′-isopropoxydiphenylsulfone, 4-hydroxy-4′-propoxydiphenylsulfone, 4-hydroxy-4′-butoxydiphenylsulfone, 4-hydroxy-4′-isobutoxydiphenylsulfone, 4-hydroxy-4′-s-butoxydiphenylsulfone, 4-hydroxy-4′-t-butoxydiphenylsulfone, 4-hydroxy-4′-benzyloxydiphenylsulfone, 4-hydroxy-4′-phenoxydiphenylsulfone, 4-hydroxy-4′-(m-methylbenzyloxy)diphenylsulfone, 4-hydroxy-4′-(p-methylbenzyloxy)diphenylsulfone, 4-hydroxy-4′-(o-methylbenzyloxy)diphenylsulfone, 4-hydroxy-4′-(p-chlorobenzyloxy)diphenylsulfone, and the like.

Moreover, a non-phenolic color developer is preferably used in view of reducing burden to the environment. The term “non-phenolic” means that a phenolic skeleton is not included. In the thermosensitive recording medium for the linerless label according to the present embodiment, a urea compound represented by Chemical Formula 1 below is more preferably used as the non-phenolic color developer.

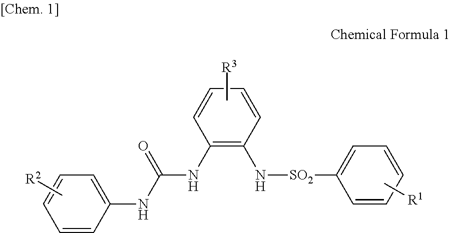

In Chemical Formula 1, R¹ to R³ are each independently a hydrogen atom, a halogen atom, a straight-chain C1 to C6 alkyl group, a C1 to C6 alkoxy group, or a C1 to C6 fluoroalkyl group.

The urea compound represented by Chemical Formula 1 above preferably includes compounds represented by at least one of Chemical Formulae 2 to 7. The urea compound represented by Chemical Formula 2 below is a compound represented by Chemical Formula 1 in which R¹, R², and R³ are all hydrogen atoms.

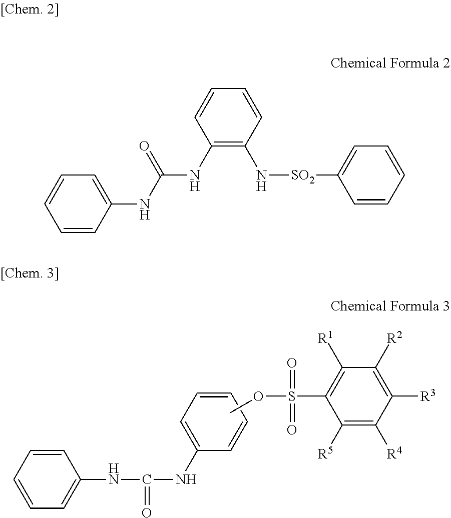

In Chemical Formula 3, R¹ to R⁵ are each independently a hydrogen atom, a halogen atom, a C1 to C6 alkyl group, a straight-chain C1 to C6 alkoxy group, or a straight-chain C1 to C6 fluoroalkyl group.

The urea compound represented by Chemical Formula 3 above may include a urea compound represented by Chemical Formula 4 below.

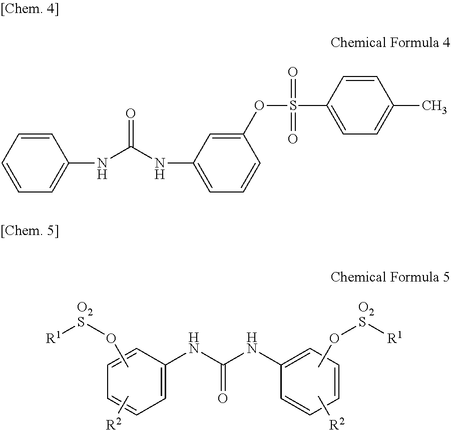

In Chemical Formula 5, each R¹ is a substituted or unsubstituted alkyl group, aralkyl group, or aryl group, and each R² is a hydrogen atom or an alkyl group.

The urea compound represented by Chemical Formula 5 is preferably a compound represented by Chemical Formula 6 or 7 below.

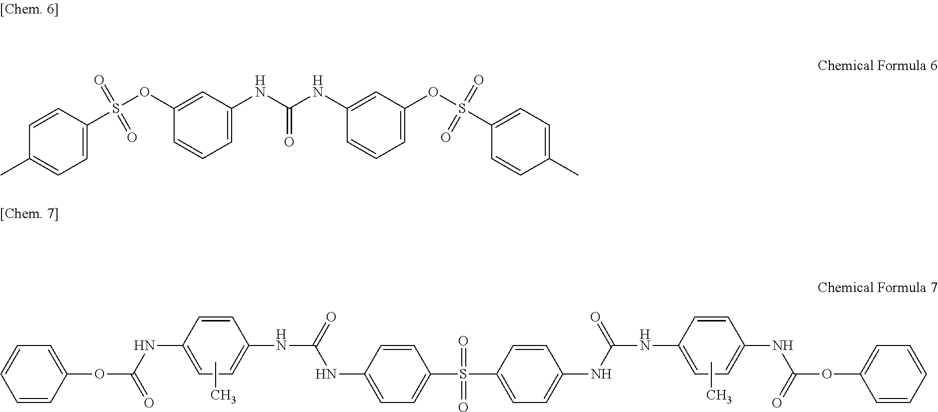

An amount of the color developer is, but not limited to, from 1 percent by mass to 20 percent by mass, and preferably from 1.5 percent by mass to 10 percent by mass, relative to 1 percent by mass of the leuco dye.

As an amount of an additional color developer, any appropriate ratio may be selected according to the intended purpose as long as the effects obtainable by the thermosensitive recording medium according to the present embodiment are not adversely affected.

### «Other Components»

The thermosensitive recording layer may further include, as other components, for example, a thermoplastic material, a binder resin, an auxiliary additive, a surfactant, a lubricant, a filler, and the like, as necessary.

### —Thermoplastic Material—

Examples of the thermoplastic material include fatty acids (e.g., stearic acid and behenic acid), fatty acid amides (e.g., stearic acid amide and palmitic acid amide), fatty acid metal salts (e.g., zinc stearate, aluminum stearate, calcium stearate, zinc palmitate, and zinc behenate), p-benzylbiphenyl, terphenyl, triphenylmethane, benzyl p-benzyloxybenzoate, β-benzyloxynaphthalene, phenyl β-naphthoate, phenyl 1-hydroxy-2-naphthoate, methyl 1-hydroxy-2-naphthoate, diphenyl carbonate, dibenzyl terephthalate, dimethyl terephthalate, 1,4-dimethoxynaphthalene, 1,4-diethoxynaphthalene, 1,4-dibenzyloxynaphthalene, 1,2-bis(phenoxy)ethane, 1,2-bis(3-methylphenoxy)ethane, 1,2-bis(4-methylphenoxy)ethane, 1,4-bis(phenoxy)butane, 1,4-bis(phenoxy)-2-butene, 1,2-bis(4-methoxyphenylthio)ethane, dibenzoyl methane, 1,4-bis(phenylthio)butane, 1,4-bis(phenylthio)-2-butene, 1,2-bis(4-methoxyphenylthio)ethane, 1,3-bis(2-vinyloxyethoxy)benzene, 1,4-bis(2-vinyloxyethoxy)benzene, p-(2-vinyloxyethoy)biphenyl, p-aryloxybiphenyl, p-propargyloxybiphenyl, benzoyloxymethane, 1,3-dibenzoyloxypropane, dibenzyldisulfide, 1,1-diphenylethanol, 1,1-diphenylpropanol, p-(benzyloxy)benzylalcohol, 1,3-diphenoxy-2-propanol, N-octadecylcarbamoyl-p-methoxycarbonylbenzene, N-octadecylcarbamoylbenzene, dibenzyl oxalate, 1,5-bis(p-methoxyphenyloxy)-3-oxapentane, and the like. The above examples may be used alone or in combination.

### —Binder Resin—

Examples of the binder resin include: polyvinyl alcohol; starch or starch derivatives; cellulose derivatives, such as hydroxymethylcellulose, hydroxyethylcellulose, carboxymethylcellulose, methylcellulose, and ethylcellulose; water-soluble polymers, such as sodium polyacrylate, polyvinyl pyrrolidone, acrylamide-acrylate copolymers, acrylamide-acrylate-methacrylic acid tercopolymers, alkaline salts of styrene-maleic anhydride copolymers, alkaline salts of isobutylene-maleic anhydride copolymers, polyacrylamide, sodium alginate, gelatin, and casein; emulsions, such as polyvinyl acetate, polyurethane, polyacrylic acid, polyacrylate, vinyl chloride-vinyl acetate copolymers, polybutyl methacrylate, and ethylene-vinyl acetate copolymers; latex, such as styrene-butadiene copolymers and styrene-butadiene-acryl copolymers; and the like. The above examples may be used alone or in combination.

### —Auxiliary Additive—

As the auxiliary additive, for example, various hindered phenol compounds or hindered amine compounds, which are electron-accepting but have relatively low coloring capability, may be used. Specific examples of the auxiliary additive include 2,2′-methylenebis(4-ethyl-6-tert-butylphenol), 4,4′-butylidenebis(6-tert-butyl-2-methylphenol), 1,1,3-tris(2-methyl-4-hydroxy-5-tert-butylphenyl)butane, 1,1,3-tris(2-methyl-4-hydroxy-5-cyclohexylphenyl)butane, 4,4′-thiobis(6-tert-butyl-2-methylphenol), tetrabromobisphenol A, tetrabromobisphenol S, 4,4-thiobis(2-methylphenol), 4,4′-thiobis(2-chlorophenol), tetrakis(1,2,2,6,6-pentamethyl-4-piperidyl)-1,2,3,4-butanetetracarboxylate, tetrakis(1,2,2,6,6-tetramethyl-4-piperidyl)-1,2,3,4-butanetetracarboxylate, and the like.

### —Surfactant—

Examples of the surfactant include anionic surfactants, nonionic surfactants, amphoteric surfactants, fluorine-based surfactant, and the like. The above examples may be used alone or in combination.

Examples of the anionic surfactants include salts of polyoxyethylene alkyl ether acetic acids, salts of dodecylbenzene sulfonic acid, laurate, salts of polyoxyethylene alkyl ether sulfates, and the like. The above examples may be used alone or in combination.

Examples of the nonionic surfactants include acetylene glycol-based surfactants, polyoxyethylene alkyl ethers, polyoxyethylene alkylphenyl ethers, polyoxyethylene alkyl esters, polyoxyethylene sorbitan fatty acid esters, and the like. The above examples may be used alone or in combination.

Examples of the acetylene glycol-based surfactants include 2,4,7,9-tetramethyl-5-decyne-4,7-diol, 3,6-dimethyl-4-octyne-3,6-diol, 3,5-dimethyl-1-hexyne-3-diol, 2,5,8,11-tetramethyl-6-dodecyne-5,8-diol, and the like. The above examples may be used alone or in combination.

Examples of the amphoteric surfactants include salts of laurylaminopropionic acids, lauryldimethylbetaine, stearyldimethylbetaine, lauryldihydroxyethylbetaine, and the like. The above examples may be used alone or in combination.

Examples of the fluorine-based surfactants include salts of perfluoroalkylsulfonic acids, salts of perfluoroalkylcarboxylic acids, esters of perfluoroalkylphosphoric acids, perfluoroalkylethylene oxide adducts, perfluoroalkyl betaine, perfluoroalkylamineoxide compounds, polyoxyalkylene ether polymers including a perfluoroalkyl ether group in a side chain or sulfate of the polyoxyalkylene ether polymers, fluorine-based aliphatic polymer esters, and the like. The above examples may be used alone or in combination.

### —Lubricant—

Examples of the lubricant include higher fatty acids and metal salts of fatty acids, higher fatty acid amides, higher fatty acid esters, animal wax, vegetable wax, mineral wax, petroleum wax, and the like.

### —Filler—

Examples of the filler include: inorganic powders, such as calcium carbonate, silica, zinc oxide, titanium oxide, aluminum hydroxide, zinc hydroxide, barium sulfate, clay, kaolin, talc, surface-treated calcium, and surface-treated silica; organic powders, such as urea-formaldehyde resins, styrene-methacrylic acid copolymers, polystyrene resins, vinylidene chloride resins; and the like.

### «Production Method for Thermosensitive Recording Layer»

The production method for the thermosensitive recording layer is not particularly limited, and the thermosensitive recording layer can be formed by any method generally known in the related art. For example, the production method for the thermosensitive recording layer is as follows. After crushing and dispersing the leuco dye, the color developer, and other components by a disperser (e.g., a ball mill, an attritor, and a sand mill) until a dispersion particle size becomes from 0.1 μm to 3 μm, and a sensitizer and optionally a filler or the like are mixed with the resultant dispersion liquid to prepare a thermosensitive recording layer coating liquid. The thermosensitive recording layer coating liquid is applied onto the support, and the applied thermosensitive recording layer coating liquid is dried, thereby forming a thermosensitive recording layer.

A coating method of the thermosensitive recording layer coating liquid is not particularly limited, and may be appropriately selected according to the intended purpose. Examples of the coating method include blade coating, gravure coating, gravure offset coating, bar coating, roll coating, knife coating, air-knife coating, comma coating, U-comma coating, AKKU coating, smoothing coating, microgravure coating, reverse roll coating, 4-roll or 5-roll coating, dip coating, single layer curtain coating, simultaneous multilayer curtain coating, slide coating, and die coating. Among the above examples, simultaneous multilayer curtain coating is preferably used because the thermosensitive recording layer can be formed simultaneously with the protective layer and the release layer on the support.

A deposition amount of the thermosensitive recording layer on a dry basis is not particularly limited, and may be appropriately selected according to the intended purpose. For example, the deposition amount of the thermosensitive recording layer on a dry basis is preferably from 0.5 g/m² to 20.0 g/m², and more preferably from 1.0 g/m² to 10.0 g/m².

### <Other Layers>

Other layers included in the thermosensitive recording medium of the present embodiment are not particularly limited, and may be appropriately selected according to the intended purpose. As the above other layers, for example, a backing layer, an undercoat layer, an intermediate layer, an adhesive layer, and the like may be used.

### «Backing Layer»

The backing layer may be optionally disposed on the side of the support where the thermosensitive recording layer is not disposed. The backing layer includes a filler and a binder resin, and may further include other components, such as color pigments, as necessary.

As the filler, for example, an inorganic filler or an organic filler can be used.

Examples of the inorganic filler include carbonates, silicates, metal oxides, sulfonic acid compounds, and the like.

Examples of the organic filler include silicone resins, cellulose, epoxy resins, nylon resins, phenolic resins, polyurethane resins, urea resins, melamine resins, polyester resins, polycarbonate resins, styrene resins, acrylic resins, polyethylene resins, formaldehyde resins, polymethylmethacrylate resins, and the like.

The binder resin is not particularly limited, and may be appropriately selected according to the intended purpose. As the binder resin, for example, the same resin as the binder resin of the thermosensitive recording layer can be used.

An average thickness of the backing layer is not particularly limited, and may be appropriately selected according to the intended purpose. The average thickness of the backing layer is preferably from 0.1 μm to 20 μm, and more preferably from 0.3 μm to 10 μm.

### «Undercoat Layer»

The undercoat layer may be disposed between the support and the thermosensitive recording layer. The undercoat layer is not particularly limited, and may be appropriately selected according to the intended purpose. The undercoat layer includes an adhesive resin and hollow thermoplastic resin particles, and may further include other components, as necessary.

Moreover, the adhesive resin is not particularly limited, and may be appropriately selected depending on the intended purpose. Examples of the adhesive resin include phenol-formaldehyde resins, urea-formaldehyde resins, melamine-formaldehyde resins, furan resins, unsaturated polyester resins formed by addition polymerization, crosslinked MMA resins, and the like.

The hollow thermoplastic resin particles are hollow particles each including a shell of a thermoplastic resin and including air or any other gas inside each particle, and are hollow particles that are already in a foamed state.

An average particle size (average particle diameter) of the hollow thermoplastic resin particles is not particularly limited, and may be appropriately selected according to the intended purpose. The average particle size of the hollow thermoplastic resin particles is preferably from 0.2 μm to 20 μm, and more preferably from 2 μm to 5 μm. When the average particle size is 0.2 μm or greater, it is technically possible to form hollow thermoplastic resin particles having a hollow structure so that a resultant undercoat layer including the hollow thermoplastic resin particles can exhibit a function as the undercoat layer. When the average particle size is 20 μm or less, reduction in smoothness of a surface of the undercoat layer after being applied and dried can be minimized so that a uniform coating of a thermosensitive recording layer can be formed on the undercoat layer, and therefore use of an excessive amount of a thermosensitive recording layer coating liquid for achieving uniform coating can be avoided. Thus, the average particle size of the hollow thermoplastic resin particles preferably has a sharp distribution peak with little variation, in addition to the average particle size of the hollow thermoplastic resin particles falling within the above range.

The average particle size of the hollow thermoplastic resin particles is an average value of outer particle shapes of the hollow thermoplastic resin particles. The average particle size is a volume-based average particle size based on effective diameters. For example, the average particle size is a particle diameter (median diameter) at which a cumulative amount of the particles accumulated from the smaller particles is 50% on a volume basis on a particle size distribution curve obtained by measuring the particle size distribution of the hollow thermoplastic resin particles according to a laser diffraction/scattering method or a dynamic light scattering method.

A hollow ratio of the hollow thermoplastic resin particles is not particularly limited, and may be appropriately selected according to the intended purpose. The hollow ratio is preferably from 30% to 95%, more preferably from 50% to 95%, and yet more preferably from 80% to 95%. When the hollow ratio is 30% or greater, sufficient thermal insulation can be ensured so that thermal energy applied from a thermal head is retained without being released from the thermosensitive recording medium via the support, and therefore a sufficient effect of improving the sensitivity can be obtained. Note that the hollow ratio is the percentage of an inner diameter of the hollow particle (a diameter of a hollow portion) to an outer diameter of the hollow particle, and can be represented by the following equation.

Hollow ratio [%]=(inner diameter of hollow particle/outer diameter of hollow particle)×100

As described above, each of the hollow thermoplastic resin particles includes a shell that includes a thermoplastic resin. The thermoplastic resin is not particularly limited, and may be appropriately selected according to the intended purpose. Examples of the thermoplastic resin include styrene-acrylic resins, polystyrene resins, acrylic resins, polyethylene resins, polypropylene resins, polyacetal resins, chlorinated polyether resins, polyvinyl chloride resins, copolymer resins including vinylidene chloride and acrylonitrile as main components, and the like. Among the above examples, a styrene-acrylic resin and a copolymer resin including vinylidene chloride and acrylonitrile as main components are preferably used in view of a high hollow ratio, a small variation in the particle size, and suitability for blade coating.

An applied amount of the hollow thermoplastic resin particles is not particularly limited, and may be appropriately selected depending on the intended purpose. In view of sensitivity and homogeneous coating, the applied amount of the hollow thermoplastic resin particles is preferably from 1 g to 3 g per 1 m² of the support. When the applied amount of the hollow thermoplastic resin particles is 1 g or greater per 1 m² of the support, sufficient sensitivity is ensured. When the applied amount of the hollow thermoplastic resin particles is 3 g or less per 1 m² of the support, cohesiveness of the undercoat layer can be ensured.

### «Intermediate Layer»

The intermediate layer is disposed, for example, between the protective layer and the thermosensitive recording layer. The intermediate layer generally includes at least a binder, and may further include an inorganic filler, a surfactant, and the like. The intermediate layer may be composed of a single layer or multiple layers.

The binder of the intermediate layer is not particularly limited, and may be appropriately selected according to the intended purpose. In the case where the intermediate layer is composed of multiple layers, the same binder or different binders may be used between the multiple intermediate layers.

Examples of the binder usable in the intermediate layer include polyvinyl alcohol, modified polyvinyl alcohol, starch, starch derivatives, cellulose derivatives, polyvinyl pyrrolidone, polyethyleneimine, sodium alginate, gelatin, casein, acrylic binders, and the like.

Moreover, as the binder of the intermediate layer, a hydrophobic resin may be used. The hydrophobic resin usable as the binder of the intermediate layer may include a resin provided as an emulsion or a resin provided as a water-soluble resin. Examples of the hydrophobic resin usable as the binder of the intermediate layer include urethane resins, epoxy resins, vinyl acetate (co)polymers, vinylidene chloride (co)polymers, vinyl chloride (co)polymers, styrene-butadiene copolymers, and the like. Examples of the binder that is particularly preferably used in the intermediate layer include polyvinyl alcohol, modified polyvinyl alcohol, and the like.

A thickness of the intermediate layer is preferably from 0.2 μm to 10 μm, and more preferably from 0.5 μm to 5 μm. In the case where the intermediate layer is composed of multiple layers, a total thickness of all of the multiple intermediate layers is preferably 5 μm or less on a dry basis.

### «Adhesive Layer»

In the thermosensitive recording medium of the present disclosure, an adhesive layer may be disposed on an opposite side of the support of the thermosensitive recording medium of the present embodiment to the side where the protective layer is disposed to thereby form a linerless label.

A material constituting the adhesive layer is not particularly limited, and may be appropriately selected depending on the intended purpose. Examples of the material of the adhesive layer include urea resins, melamine resins, phenolic resins, epoxy resins, vinyl acetate resins, vinyl acetate-acryl copolymers, ethylene-vinyl acetate copolymers, acrylic resins, polyvinyl ether resins, vinyl chloride-vinyl acetate copolymers, polystyrene resins, polyester resins, polyurethane resins, polyamide resins, chlorinated polyolefin resins, polyvinyl butyral resins, acrylate copolymers, methacrylate copolymers, natural rubber, cyanoacrylate resins, silicone resins, and the like. The above examples may be used alone or in combination.

In a typical application of the thermosensitive recording medium according to the present embodiment, the adhesive layer is useful, for example, for attaching the thermosensitive recording medium to a food package. Therefore, the thermosensitive recording medium according to the present embodiment can include an adhesive surface provided to the support or the backing layer so that the thermosensitive recording medium of the present embodiment is effective for providing a label having an adhesive layer. For the adhesive layer, a releasable liner may be provided to the adhesive layer, and the liner may be removed before finally adhering the thermosensitive recording medium to a tagged product. Further, the adhesive layer may have antistatic properties.

As described earlier, a microsphere adhesive is more preferably used in the adhesive layer of a process control label in view of easiness in readhesion.

A coating method of the adhesive is not particularly limited, and may be appropriately selected according to the intended purpose. Examples of the coating method include methods using roll coaters, knife coaters, bar coaters, slot die coaters, curtain coaters, and the like.

Moreover, the adhesive layer may be directly applied onto the backing layer. Alternatively, the adhesive layer may be applied to and dried on a separate support having a release property, and then subjected to laminate processing or the like, followed by transferring the adhesive layer onto the backing layer. In the case where a microsphere adhesive is applied, the adhesive layer is preferably directly applied onto an opposite side of the support to the side where the thermosensitive layer is provided, or onto the backing layer in order to appropriately exhibit the function of the adhesive layer.

An average thickness of the adhesive layer is not particularly limited, and may be appropriately selected depending on the intended purpose. The average thickness of the adhesive layer may be from 0.1 μm to 20 μm.

### (Method of Producing Thermosensitive Recording Medium for Linerless Label)

A method of producing a thermosensitive recording medium for a linerless label according to the present embodiment is a method of producing the thermosensitive recording medium for the linerless label of the present embodiment. The method of producing the thermosensitive recording medium for the linerless label of the present embodiment includes single-pass coating to form the above-described thermosensitive recording layer, protective layer, and release layer on the above-described support.

In the present specification, the single-pass coating encompasses a coating method in which, when coating liquids respectively corresponding to the thermosensitive recording layer, the protective layer, and the release layer are applied onto the support by a coater, all of the coating liquids are applied in a region of the support that is from the feeder to the winder. In the above case, the coating methods for the respective layers may not necessarily be the same.

As one example of the single-pass coating, the following method using a coater, in which three stations of bar coaters, and dryers respectively provided for the three stations are disposed between a feeder and a winder, is exemplified. A support is fed from the feeder. First, a thermosensitive recording layer is applied by the bar coater of the first station and dried by the first dryer, then a protective layer is applied by the bar coater of the second station and dried by the second dryer, and a release layer is applied by the bar coater of the third station and dried by the third dryer, followed by winding the resultant stack by the winder.

Moreover, as another example of the single-pass coating, the following method using a coater, in which one simultaneous two-layer curtain coater, one bar coater, and dryers respectively provided for the curtain coater and the bar coater are provided between a feeder and a winder, is exemplified. A support is fed from the feeder. First, a thermosensitive layer and a protective layer are simultaneously applied onto the support by the simultaneous two-layer curtain coater of the first station and dried by the first dryer, and a release layer is applied by the bar coater of the second station and dried by the second dryer, followed by winding the resultant stack by the winder.

Examples of a coating method that does not correspond to the single-pass coating include a production method in which a support is fed from a feeder, a thermosensitive layer is applied to the support and dried by a dryer, followed by temporarily winding of the resultant stack by a winder, the resultant stack is transferred to another coater and is fed from a feeder, and a protective layer and a release layer are applied and dried by a dryer, followed by winding by a winder.

Since the above single-pass coating is employed in the method of producing the thermosensitive recording medium for the linerless label of the present embodiment, a thermosensitive recording medium for a linerless label can be stably produced at high speed.

In addition, the method of producing the thermosensitive recording medium for the linerless label of the present embodiment includes simultaneous multilayer curtain coating to simultaneously form the above-described thermosensitive recording layer, protective layer, and release layer on the above-described support. The simultaneous multilayer curtain coating encompasses a method in which coating liquids of the thermosensitive recording layer, the protective layer, and the release layer are simultaneously ejected in the form of layers, and the ejected multilayer stack formed in the air is applied onto the support. The multilayer stack may be in the form of a liquid, a semi-solid, or a solid.

Since the above simultaneous multilayer curtain coating is employed in the thermosensitive recording medium for the linerless label of the present embodiment, a thermosensitive recording medium for a linerless label can be efficiently produced at high speed.

Since the above simultaneous multilayer curtain coating is employed in the thermosensitive recording medium for the linerless label of the present embodiment, moreover, cost efficiency is improved, uniformity of a coated layer is improved, and printer matching (conformability with a printer) is improved owing to improvement in adhesion between the protective layer and the release layer.

### (Recording Method)

A recording method using the thermosensitive recording medium according to the present embodiment is not particularly limited, and may be appropriately selected according to the intended purpose. Examples of the recording method include methods using thermal heads, lasers, and the like.

A shape, structure, size, and the like of the thermal head are not particularly limited, and may be appropriately selected according to the intended purpose.

The laser is not particularly limited, and may be appropriately selected according to the intended purpose. Examples of the laser include CO₂ lasers emitting beams having the wavelength of 9.3 μm to 10.6 μm, semiconductor lasers, and the like.

### (Use)

The thermosensitive recording medium for the linerless label according to the present embodiment has excellent oil resistance, releasability, and printing operability with a printer. Therefore, the thermosensitive recording medium for the linerless label according to the present embodiment can be used in various fields, examples of which include: the POS field for fresh food products, packaged food products, and products for deli dishes; the copying field, such as books and documents; the communication field, such as facsimile machines; the ticketing field, such as ticketing machines and receipts; the aviation field, such as airport luggage tags; the medical field, such as medical containers (e.g., pill cases and pill bottles); and the field of the food service industry, such as process control labels and customer identification labels for fast foods. Since the thermosensitive recording medium according to the present embodiment has excellent oil resistance or excellent releasability even when microsphere adhesive is used, the thermosensitive recording medium can particularly suitably be used as a process control label or customer identification label in the food service industry.

### (Article)

The article according to the present embodiment includes an article main body and the thermosensitive recording medium according to the present embodiment, which is provided to the article main body. As the thermosensitive recording medium, the thermosensitive recording medium according to the present embodiment can be suitably used. The phrase “the thermosensitive recording medium according to the present embodiment, which is provided to the article main body” encompasses the state in which the thermosensitive recording medium of the present embodiment is adhered to or mounted to the article main body, or the like.

The present embodiment has been described above, but the above embodiment is merely provided as an example and shall not be construed as limiting the present invention. The above embodiment can be performed in various other forms, and various combinations, omissions, substitutions, modifications or the like can be made without departing from the spirit of the invention.

These embodiments and modifications are included in the scope and spirit of the invention, and are included within the scope of the invention described herein and the equivalents of the invention.

### EXAMPLES

The present disclosure will be more specifically described through Examples and Comparative Examples hereinafter, but the present disclosure is not limited to Examples and Comparative Examples. In Examples and Comparative Examples below, “%” denotes percent by mass, unless otherwise stated.

### Example 1

### <Preparation of Coating Liquids>

### «Preparation of Undercoat Layer Coating Liquid»

Components of the following composition were mixed and stirred to prepare an undercoat layer coating liquid.
Hollow particles (copolymer of acrylonitrile, methacrylonitrile, and isobonyl methacrylate, hollow ratio: 90%, volume-based average particle size: 4.4 μm, solid content: 33 percent by mass): 20 parts by mass
Styrene/butadiene copolymer latex (solid content: 47.5 percent by mass): 20 parts by mass
10 percent by mass polyvinyl alcohol aqueous solution (PVA117, produced by KURARAY CO., LTD.): 20 parts by mass
Ion-exchanged water: 40 parts by mass

### <Preparation of [Liquid E] (Thermosensitive Recording Layer Coating Liquid)>

A leuco dye dispersion liquid [Liquid A], a main color developer dispersion liquid [Liquid B], auxiliary color developer dispersion liquids [Liquid C1] and [Liquid C2], and a sensitizer dispersion liquid [Liquid D] respectively having the following compositions were each dispersed and prepared by a sand grinder so that volume-based average particle sizes were 0.5 μm ([Liquid A]), 1.0 μm ([Liquid B]), 1.0 μm ([Liquid C1] and [Liquid C2]), and 1.0 μm ([Liquid D]), respectively.

Next, 20 parts by mass of [Liquid A], 35 parts by mass of [Liquid B], 11 parts by mass of [Liquid C1], 22 parts by mass of [Liquid C2], 10 parts by mass of [Liquid D], and 20 parts by mass of a 10 percent by mass itaconic acid-modified polyvinyl alcohol aqueous solution were mixed and stirred, thereby preparing a thermosensitive recording layer coating liquid.

### <<<Composition of [Liquid A] (Leuco Dye Dispersion Liquid)>>>

Leuco dye (3-dibutylamino-6-methyl-7-anilinofluoran): 20 parts by mass
10 percent by mass itaconic acid-modified polyvinyl alcohol aqueous solution (25-88KL, produced by KURARAY CO., LTD.; degree of polymerization: 1,800): 40 parts by mass
Surfactant (Newcol (registered trademark) 290, produced by Nippon Nyukazai Co., Ltd.; solid content: 100 percent by mass): 0.2 parts by mass
Ion-exchanged water: 40 parts by mass

### <<<Composition of [Liquid B] (Main Color Developer Dispersion Liquid)>>>

N-[2-(3-phenylureido)phenyl]benzenesulfoneamide (NKK-1304, produced by Nippon Soda Co., Ltd.): 20 parts by mass
10 percent by mass itaconic acid-modified polyvinyl alcohol aqueous solution (25-88KL, produced by KURARAY CO., LTD.; degree of polymerization: 1,800): 20 parts by mass
Amorphous silica (MIZUKASIL (registered trademark) P527, produced by Mizusawa Industrial Chemicals, Ltd.): 15 parts by mass
Surfactant (PD-001, produced by Nissin Chemical Industry Co., Ltd.; solid content: 100 percent by mass): 0.2 parts by mass
Ion-exchanged water: 65 parts by mass

### <<<Composition of [Liquid C1] (Auxiliary Color Developer Dispersion Liquid)>>>

1,3-diphenylurea: 20 parts by mass
10 percent by mass sulfone-modified polyvinyl alcohol aqueous solution (GOHSERAN (registered trademark) L-3266, produced by Nippon Synthetic Chemical Industry Co., Ltd.): 20 parts by mass
Surfactant (PD-001, produced by Nissin Chemical Industry Co., Ltd.; solid content: 100 percent by mass): 0.2 parts by mass
Ion-exchanged water: 35 parts by mass

### <<<Composition of [Liquid C2] (Auxiliary Color Developer Dispersion Liquid)>>>

Urea compound represented by Chemical Formula 4 (TG-MD, produced by Nippon Kayaku Co., Ltd.): 20 parts by mass
10 percent by mass sulfone-modified polyvinyl alcohol aqueous solution (GOHSERAN (registered trademark) L-3266, produced by Nippon Synthetic Chemical Industry Co., Ltd.): 20 parts by mass
Surfactant (PD-001, produced by Nissin Chemical Industry Co., Ltd.; solid content: 100 percent by mass): 0.2 parts by mass
Ion-exchanged water: 35 parts by mass

### <<<Composition of [Liquid D] (Sensitizer Dispersion Liquid)>>>

1,2-bis(3-methylphenoxy)ethane (KS-232, produced by Sanko Co., Ltd.): 10 parts by mass
10 percent by mass sulfone-modified polyvinyl alcohol aqueous solution (GOHSERAN (registered trademark) L-3266, produced by Nippon Synthetic Chemical Industry Co., Ltd.): 10 parts by mass
Surfactant (PD-001, produced by Nissin Chemical Industry Co., Ltd.; solid content: 100 percent by mass): 0.1 parts by mass
Ion-exchanged water: 25 parts by mass

### «Preparation of [Liquid G1] (Protective Layer Coating Liquid)»

Thirty parts by mass (30 parts by mass) of an aqueous solution of aluminum hydroxide, 30 parts by mass of 10 percent by mass itaconic acid-modified polyvinyl alcohol aqueous solution (25-88KL, produced by KURARAY CO., LTD.; degree of polymerization: 1,800), and 40 parts by mass of ion-exchanged water were stirred and dispersed by a sand grinder so that a volume-based average particle size became 0.5 μm, thereby preparing a protective layer dispersion liquid [Liquid F1].

As described below, components of the following composition were mixed and stirred to prepare a PVA-based protective layer coating liquid [Liquid G1].

### <<<Composition of [Liquid G1] (Protective Layer Coating Liquid)>>>

Protective layer dispersion liquid [Liquid F1]: 30 parts by mass
10 percent by mass itaconic acid-modified polyvinyl alcohol aqueous solution (25-88KL, produced by KURARAY CO., LTD.; degree of polymerization: 1,800): 50 parts by mass
Crosslinking agent (polyamide epichlorohydrin resin; Kymene (registered trademark) 925NA, produced by Solenis; solid content: 25 percent by mass): 8 parts by mass
Polyethylene oxide emulsion dispersion liquid (solid content: 30 percent by mass): 15 parts by mass Ion-exchanged water: 15 parts by mass

### «Preparation of [Liquid H1] (Release Layer Coating Liquid)»

Components of the following composition were mixed and stirred to prepare a release layer coating liquid.
Vinyl group-containing polydimethylsiloxane (DEHESIVE (registered trademark) EM492, produced by WACKER; solid content: 50 percent by mass): 30 parts by mass
Release material (crosslinking agent for dimethylsilicone; CROSSLINKER V15, produced by WACKER; solid content: 40 percent by mass): 5 parts by mass
Platinum catalyst (CATALYST EM459, produced by WACKER; solid content: 50 percent by mass): 15 parts by mass
Crosslinking agent (polyamide epichlorohydrin resin; Kymene (registered trademark) 925NA, produced by Solenis; solid content: 25 percent by mass): 3 parts by mass
Ion-exchanged water: 60 parts by mass

### <Production of Thermosensitive Recording Medium for Linerless Label>

The undercoat layer coating liquid was applied onto a surface of paper having a basis weight of 60 g/m², serving as a support, by a wire bar in a manner such that the deposition amount was to be 3.0 g/m² on a dry basis, and the applied undercoat layer coating liquid was dried to form an undercoat layer. The thermosensitive recording layer coating liquid [Liquid E] was applied onto the undercoat layer by a wire bar in a manner such that the deposition amount was to be 3.0 g/m² on a dry basis, and the applied thermosensitive recording layer coating liquid [Liquid E] was dried to form a thermosensitive recording layer. The protective layer coating liquid [Liquid G1] was applied onto the thermosensitive recording layer by a wire bar in a manner that the deposition amount was to be 2.5 g/m² on a dry basis, and the applied protective layer coating liquid [Liquid G1] was dried to form a protective layer. The release layer coating liquid [Liquid H1] was applied onto the protective layer by a wire bar in a manner such that the deposition amount was to be 1.0 g/m² on a dry basis, and the applied release layer coating liquid [Liquid H1] was dried to form a release layer.

Next, a surface treatment was performed by super calendering so that the surface smoothness was to be from 1,500 seconds to 2,500 seconds, and the resultant stacked layers were sealed in a high density polyethylene bag in an atmosphere of 40° C. to cure the layers for a predetermined time.

### Example 2

A thermosensitive recording medium for a linerless label of Example 2 was produced in the same manner as in Example 1, except that the release layer coating liquid [Liquid H1] was replaced with the following [Liquid H2].

### «Preparation of [Liquid H2] (Release Layer Coating Liquid)»

Components of the following composition were mixed and stirred to prepare a release layer coating liquid.
Release material (long-chain alkylacrylate; Resem K256, produced by CHUKYO YUSHI CO., LTD.; solid content: 20 percent by mass): 96 parts by mass
Crosslinking agent (polyamide epichlorohydrin resin; Kymene 925NA, produced by Solenis; solid content: 25 percent by mass): 3 parts by mass
Ion-exchanged water: 1 part by mass

### Example 3

A thermosensitive recording medium for a linerless label of Example 3 was produced in the same manner as in Example 1, except that the release layer coating liquid [Liquid H1] was replaced with the following [Liquid H3].

### «Preparation of [Liquid H3] (Release Layer Coating Liquid)»

Components of the following composition were mixed and stirred to prepare a release layer coating liquid.
Release material (silicone-modified acrylic; SUNCRYL 2555, produced by Synhomer; solid content: 37 percent by mass): 52 parts by mass
Crosslinking agent (polyamide epichlorohydrin resin; Kymene 925NA, produced by Solenis; solid content: 25 percent by mass): 3 parts by mass
Ion-exchanged water: 45 parts by mass

### Example 4

A thermosensitive recording medium for a linerless label of Example 4 was produced in the same manner as in Example 1, except that the release layer coating liquid [Liquid H1] was replaced with the following [Liquid H4].

### «Preparation of [Liquid H4] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 96 parts by mass
Crosslinking agent (epichlorohydrin resin, produced by Tokyo Chemical Industry Co., Ltd.): 1 part by mass
Ion-exchanged water: 3 parts by mass

### Example 5

A thermosensitive recording medium for a linerless label of Example 5 was produced in the same manner as in Example 1, except that the release layer coating liquid [Liquid H1] was replaced with the following [Liquid H5].

### «Preparation of [Liquid H5] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 96 parts by mass
Crosslinking agent (oxazoline group-containing polymer; EPOCROS (registered trademark) WS500, produced by NIPPON SHOKUBAI CO., LTD.; solid content: 39 percent by mass): 2 parts by mass
Ion-exchanged water: 2 parts by mass

### Example 6

A thermosensitive recording medium for a linerless label of Example 6 was produced in the same manner as in Example 1, except that the release layer coating liquid [Liquid H1] was replaced with the following [Liquid H6], and the protective layer coating liquid [Liquid G1] was replaced with the following PVA-based protective layer coating liquid [Liquid G2].

### «Preparation of [Liquid H6] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 96 parts by mass
Crosslinking agent (hydrazine hydrate, produced by Tokyo Chemical Industry Co., Ltd.): 1 part by mass
Ion-exchanged water: 2 parts by mass

### <<<Composition of [Liquid G2] (Protective Layer Coating Liquid)>>>

Protective layer dispersion liquid [Liquid F1]: 30 parts by mass
10 percent by mass carbonyl group-modified polyvinyl alcohol aqueous solution (DF-17, produced by JAPAN VAM & POVAL CO., LTD.; degree of polymerization: 1,700): 50 parts by mass
10% adipic acid dihydrazide aqueous solution: 10 parts by mass
Polyethylene oxide emulsion dispersion liquid (solid content: 30 percent by mass): 15 parts by mass 1% ammonia aqueous solution: 3 parts by mass
Ion-exchanged water: 15 parts by mass

### Example 7

A thermosensitive recording medium for a linerless label of Example 7 was produced in the same manner as in Example 6, except that the release layer coating liquid [Liquid H6] was replaced with the following [Liquid H7].

### «Preparation of [Liquid H7] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 86 parts by mass
10% adipic acid dihydrazide aqueous solution (hydrazide derivative): 7 parts by mass
Ion-exchanged water: 8 parts by mass

### Example 8

A thermosensitive recording medium for a linerless label of Example 8 was produced in the same manner as in Example 1, except that the release layer coating liquid [Liquid H1] was replaced with the following [Liquid H8].

### «Preparation of [Liquid H8] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 78.95 parts by mass
10 percent by mass itaconic acid-modified polyvinyl alcohol aqueous solution (25-88KL, produced by KURARAY CO., LTD; degree of polymerization: 1,800): 15.79 parts by mass
Crosslinking agent (polyamide epichlorohydrin resin, Kymene 925NA, produced by Solenis; solid content: 25 percent by mass): 2.5 parts by mass
Ion-exchanged water: 3 parts by mass

### Example 9

A thermosensitive recording medium for a linerless label of Example 9 was produced in the same manner as in Example 8, except that the protective layer coating liquid [Liquid G1] was replaced with the following acrylic protective layer coating liquid [Liquid G3].

### «Preparation of [Liquid G3] (Protective Layer Coating Liquid)»

Forty and seven-tenths parts by mass (40.7 parts by mass) of calcium carbonate, 11.3 parts by mass of a carboxyl group-containing acrylic resin aqueous solution (HPD-196, produced by BASF; solid content: 36%), 2 parts by mass of a surfactant (PD-001, produced by Nissin Chemical Industry Co., Ltd.; solid content: 10%), and 46 parts by mass of ion-exchanged water were added, and the resultant mixture was dispersed by a sand mill in a manner such that a volume-based 50% cumulative particle size (median diameter (D50)) determined by a laser diffraction/scattering particle size distribution analyzer (LA-960, produced by HORIBA, Ltd.) was to be 0.2 μm or less, thereby preparing a protective layer dispersion liquid [Liquid F3].

Next, 19.9 parts by mass of the obtained protective layer dispersion liquid [Liquid F3], 21.9 parts by mass of an acrylic emulsion (EK-61, produced by SAIDEN CHEMICAL INDUSTRY CO., LTD.; solid content: 41%), 9.2 parts by mass of an oxazoline group-containing polymer emulsion (WS-500, produced by NIPPON SHOKUBAI CO., LTD.; solid content: 39%), 4.5 parts by mass of polyethylene oxide emulsion (Hydrin (registered trademark) P-960, produced by CHUKYO YUSHI CO., LTD.; solid content: 30%), and 44.5 parts by mass of ion-exchanged water were mixed and stirred, thereby preparing an acrylic protective layer coating liquid [Liquid G3].

### Example 10

A thermosensitive recording medium for a linerless label of Example 10 was produced in the same manner as in Example 1, except that the release layer coating liquid [Liquid H1] was replaced with the following [Liquid H9].

### «Preparation of [Liquid H9] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 78.95 parts by mass
10 percent by mass carboxyl group-containing modified polyvinyl alcohol aqueous solution (AP17, produced by JAPAN VAM & POVAL CO., LTD.; degree of polymerization: 1,700): 15.79 parts by mass
Crosslinking agent (polyamide epichlorohydrin resin; Kymene 925NA, produced by Solenis; solid content: 25 percent by mass): 2.5 parts by mass
Ion-exchanged water: 3 parts by mass

### Example 11

A thermosensitive recording medium for a linerless label of Example 11 was produced in the same manner as in Example 1, except that the release layer coating liquid [Liquid H1] was replaced with the following [Liquid H10].

### «Preparation of [Liquid H10] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 78.95 parts by mass
25 percent by mass itaconic acid-modified polyvinyl alcohol aqueous solution (3-86SD, produced by KURARAY CO., LTD.; degree of polymerization: 250): 15.79 parts by mass
Crosslinking agent (polyamide epichlorohydrin resin; Kymene 925NA, produced by Solenis; solid content: 25 percent by mass): 2.5 parts by mass
Ion-exchanged water: 3 parts by mass

### Example 12

A thermosensitive recording medium for a linerless label of Example 12 was produced in the same manner as in Example 1, except that the release layer coating liquid [Liquid H1] was replaced with the following [Liquid H11].

### «Preparation of [Liquid H11] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 85.71 parts by mass
10 percent by mass carboxyl group-containing modified polyvinyl alcohol aqueous solution (AP17, produced by JAPAN VAM & POVAL CO., LTD.; degree of polymerization: 1,700): 1.71 parts by mass
Crosslinking agent (polyamide epichlorohydrin resin; Kymene 925NA, produced by Solenis; solid content: 25 percent by mass): 2.7 parts by mass
Ion-exchanged water: 10 parts by mass

### Example 13

A thermosensitive recording medium for a linerless label of Example 13 was produced in the same manner as in Example 1, except that the release layer coating liquid [Liquid H1] was replaced with the following [Liquid H12].

### «Preparation of [Liquid H12] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 68.55 parts by mass
10 percent by mass carboxyl group-containing modified polyvinyl alcohol aqueous solution (AP17, produced by JAPAN VAM & POVAL CO., LTD.; degree of polymerization: 1,700): 27.42 parts by mass
Crosslinking agent (polyamide epichlorohydrin resin; Kymene 925NA, produced by Solenis; solid content: 25 percent by mass): 2.10 parts by mass
Ion-exchanged water: 4 parts by mass

### Example 14

A thermosensitive recording medium for a linerless label of Example 14 was produced in the same manner as in Example 1, except that the release layer coating liquid [Liquid H1] was replaced with the following [Liquid H13].

### «Preparation of [Liquid H13] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 65.89 parts by mass
10 percent by mass carboxyl group-containing modified polyvinyl alcohol aqueous solution (AP17, produced by JAPAN VAM & POVAL CO., LTD.; degree of polymerization: 1,700): 32.95 parts by mass
Crosslinking agent (polyamide epichlorohydrin resin; Kymene 925NA, produced by Solenis; solid content: 25 percent by mass): 2.1 parts by mass
Ion-exchanged water: 1 part by mass

### Example 15

A thermosensitive recording medium for a linerless label of Example 15 was produced in the same manner as in Example 6, except that the release layer coating liquid [Liquid H6] was replaced with the following [Liquid H14].

### «Preparation of [Liquid H14] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 74.56 parts by mass
10 percent by mass carbonyl group-containing modified polyvinyl alcohol aqueous solution (DF05, produced by JAPAN VAM & POVAL CO., LTD.; degree of polymerization: 500): 14.91 parts by mass
10% adipic acid dihydrazide aqueous solution: 5.96 parts by mass
Ion-exchanged water: 1 part by mass

### Example 16

A thermosensitive recording medium for a linerless label of Example 16 was produced in the same manner as in Example 15, except that the release layer coating liquid [Liquid H14] was replaced with the following [Liquid H15].

### «Preparation of [Liquid H15] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 74.56 parts by mass
10 percent by mass carbonyl group-containing modified polyvinyl alcohol aqueous solution (DF20, produced by JAPAN VAM & POVAL CO., LTD.; degree of polymerization: 2,000): 14.91 parts by mass
10% adipic acid dihydrazide aqueous solution: 5.96 parts by mass
Ion-exchanged water: 1 part by mass

### Example 17

The same support as the support used in Example 1 was used, and the same procedure as Example 1 was repeated up to the formation of the undercoat layer. Then, a thermosensitive recording layer coating liquid [Liquid E], a protective layer coating liquid [Liquid G1], and a release layer coating liquid [Liquid H8] were applied onto the undercoat layer by simultaneous multilayer curtain coating in a manner such that the deposition amounts were to be 3.0 g/m², 2.5 g/m², and 1.0 g/m², respectively, on a dry basis. The applied layers were dried, thereby simultaneously forming a thermosensitive recording layer, a protective layer, and a release layer.

Next, in the same manner as in Example 1, a surface treatment was performed by super calendering so that the surface smoothness was to be from 1,500 seconds to 2,500 seconds, and the resultant stacked layers were sealed in a high density polyethylene bag in an atmosphere of 40° C. to cure the layers for a predetermined time.

### Comparative Example 1

A thermosensitive recording medium for a linerless label of Comparative Example 1 was produced in the same manner as in Example 1, except [Liquid H1] used as the release layer coating liquid was omitted.

### Comparative Example 2

A thermosensitive recording medium for a linerless label of Comparative Example 2 was produced in the same manner as in Example 1, except that the release layer coating liquid [Liquid H1] was replaced with the following [Liquid H16].

### «Preparation of [Liquid H16] (Release Layer Coating Liquid)»

Components of the following composition were mixed and stirred to prepare a release layer coating liquid.
Release material (long-chain alkyl acrylate; Resem K256, produced by CHUKYO YUSHI CO., LTD.; solid content: 20 percent by mass): 96 parts by mass
Ion-exchanged water: 4 parts by mass

### Comparative Example 3

A thermosensitive recording medium for a linerless label of Comparative Example 3 was produced in the same manner as in Example 2, except that [Liquid G1] used as the protective layer coating liquid was omitted.

### Comparative Example 4

A thermosensitive recording medium for a linerless label of Comparative Example 4 was produced in the same manner as in Example 17, except that [Liquid H8] used as the release layer coating liquid was omitted.

### Evaluations of Properties

Next, the properties of each of the produced thermosensitive recording media for linerless labels were evaluated. As the properties of each thermosensitive recording medium for a linerless label, oil resistance, releasability, and printer matching (conformability with a printer) were evaluated.

### <Oil Resistance>

Printing was performed on each sample under the conditions of 2 kg/cm² and 2.0 seconds by a heat gradient tester (produced by Tokyo Seiki Seisaku-sho, Ltd.) using a heat block having a temperature at which the sample reached the saturated density, thereby preparing a pre-test image sample. The density of the printed image on each pre-test image sample was measured by a Macbeth densitometer (RD-914, produced by Macbeth). In addition, cotton seed oil was applied once over the region of the pre-test image sample, in which the density of the imaging part and the density of the non-imaging part could be measured, using a cotton wool impregnated with the cotton seed oil, and then the sample was left to stand in a thermostatic bath at 80° C. for 24 hours. The image density of the sample after being left to stand for 24 hours was measured by the Macbeth densitometer, and an image density retention ratio after the test with respect to the density value before the test was calculated (see the following equation). Oil resistance was evaluated according to the following evaluation criteria based on the obtained image density retention ratio.

Image density retention ratio [%]=(image density after test)/(image density before test)×100

### Evaluation Criteria

Very good: The image density retention ratio was 1.1% or greater.
Good: The image density retention ratio was 1.0% or greater and less than 1.1%.
Fair: The image density retention ratio was 0.8% or greater and less than 1.0%.
Poor: The image density retention ratio was less than 0.8%.

### <Printer Matching>

The printer matching (conformability with a printer) was evaluated based on printing noise generated when a sample was printed with a thermal head. As illustrated in the FIGURE, the produced thermosensitive recording medium for the linerless label was cut into a size having a width W of 50 mm and the length L of 300 mm. Then, the cut piece was stored for 24 hours in an atmosphere of 5° C. and 30% RH to prepare a test sample S.

After the storage, a pattern P was printed on the test sample at the pitch D by a thermal printer (QL420Plus, produced by Zebra) in an atmosphere of 5° C. and 30% RH under the conditions in which IPS was set to 3 and Darkness was set to 200. During the printing, the printing noise was measured by a sound meter (Sound meter 840029, produced by Sper Scientific). The printer matching (conformability with the printer) was evaluated according to the following evaluation criteria based on the loudness of the measured printing noise. Note that the larger the printing noise is, the poorer the matching (conformability) is.

### Evaluation Criteria

Very good: The printing noise was less than 80 dB.
Good: The printing noise was 80 dB or greater and less than 90 dB.
Fair: The printing noise was 90 dB or greater and less than 100 dB.
Poor: The printing noise was 100 dB or greater.

### <Releasability>

A microsphere adhesive (ORIBAIN (registered trademark) BPW5954, produced by TOYOCHEM CO., LTD.; solid content: 25 percent by mass) was applied to a surface of paper having a basis weight of 60 g/m², serving as a support, by a wire bar in a manner such that the deposition amount was to be 6.0 g/m² on a dry basis, and the applied adhesive was dried to form an adhesive layer.

The adhesive layer formed on the support and each of the release layers of Examples 1 to 17 and Comparative Examples 2 to 3 and the protective layers of Comparative Examples 1 and 4 were bonded to produce a sample.

Each of the produced samples was cut into a size having a length of 300 mm and a width of 40 mm, and the cut sample was pressurized by running a roller (a manual tape adhesion roll SA-1003-B, produced by TESTER SANGYO CO., LTD.) over the entire area of the cut sample twice in the reciprocating movement, followed by storing the sample for 24 hours in an atmosphere of 23° C. and 50% RH.

The sample, which had been stored in the above manner, was subjected to measurement of peel strength between the adhesive layer and the release layer by a tension compression testing machine (SDT-204F, produced by IMADA SEISAKUSHO CO., LTD.) at the tensile speed of 300 mm/min in an atmosphere of 23° C. and 50% RH. The releasability was evaluated according to the following evaluation criteria based on the obtained peel strength.

### Evaluation Criteria

Very good: The peel strength was 100 mN/40 mm or greater and less than 300 mN/40 mm.
Good: The peel strength was 300 mN/40 mm or greater and less than 500 mN/40 mm, or less than 100 mN/40 mm.
Fair: The peel strength was 500 mN/40 mm or greater and less than 1,000 mN/40 mm.
Poor: The peel strength was 1,000 mN/40 mm or greater.

Note that the evaluation results of “Fair” or better in the oil resistance, printer matching (conformability with the printer), and releasability satisfy usable conditions.

TABLE 1
CONDITIONS

| | | RELEASE LAYER | | | | |
|---|---|---|---|---|---|---|
| | | PVA | | | | |
| | | DEGREE OF | PVA % mass | | | |
| | PROTECTIVE | POLYMERI- | TO RELEASE | CROSSLINKING | | COATING |
| | LAYER | ZATION | LAYER | AGENT | RELEASE MATERIAL | METHOD |
| EX 1 | PVA-BASED | NA | | POLYAMIDE | DIMETHYL SILICONE | WIRE BAR |
| | | | | EPICHLOROHYDRIN | | |
| EX. 2 | PVA-BASED | NA | | POLYAMIDE | LONG-CHAIN ALKYL ACRYLATE | WIRE BAR |
| | | | | EPICHLOROHYDRIN | | |
| EX. 3 | PVA-BASED | NA | | POLYAMIDE | SILICONE-MODIFIED ACRYL | WIRE BAR |
| | | | | EPICHLOROHYDRIN | | |
| EX. 4 | PVA-BASED | NA | | EPICHLOROHYDRIN | LONG-CHAIN ALKYL ACRYLATE | WIRE BAR |
| EX. 5 | PVA-BASED | NA | | OXAZOLINE | LONG-CHAIN ALKYL ACRYLATE | WIRE BAR |
| | | | | DERIVATIVE | | |
| EX. 6 | PVA-BASED | NA | | HYDRAZINE | LONG-CHAIN ALKYL ACRYLATE | WIRE BAR |
| | | | | HYDRATE | | |
| EX. 7 | PVA-BASED | NA | | HYDRAZIDE | LONG-CHAIN ALKYL ACRYLATE | WIRE BAR |
| | | | | DERIVATIVE | | |
| EX. 8 | PVA-BASED | 1800 | 10% mass | POLYAMIDE | LONG-CHAIN ALKYL ACRYLATE | WIRE BAR |
| | | | | EPICHLOROHYDRIN | | |
| EX. 9 | ACRYLIC | 1800 | 10% mass | POLYAMIDE | LONG-CHAIN ALKYL ACRYLATE | WIRE BAR |
| | | | | EPICHLOROHYDRIN | | |
| EX. 10 | PVA-BASED | 1700 | 10% mass | POLYAMIDE | LONG-CHAIN ALKYL ACRYLATE | WIRE BAR |
| | | | | EPICHLOROHYDRIN | | |
| EX. 11 | PVA-BASED | 250 | 25% mass | POLYAMIDE | LONG-CHAIN ALKYL ACRYLATE | WIRE BAR |
| | | | | EPICHLOROHYDRIN | | |
| EX 12 | PVA-BASED | 1700 | 10% mass | POLYAMIDE | LONG-CHAIN ALKYL ACRYLATE | WIRE BAR |
| | | | | EPICHLOROHYDRIN | | |
| EX. 13 | PVA-BASED | 1700 | 10% mass | POLYAMIDE | LONG-CHAIN ALKYL ACRYLATE | WIRE BAR |
| | | | | EPICHLOROHYDRIN | | |
| EX. 14 | PVA-BASED | 1700 | 10% mass | POLYAMIDE | LONG-CHAIN ALKYL ACRYLATE | WIRE BAR |
| | | | | EPICHLOROHYDRIN | | |
| EX. 15 | PVA-BASED | 500 | 10% mass | HYDRAZIDE | LONG-CHAIN ALKYL AGRYLATE | WIRE BAR |
| | | | | DERIVATIVE | | |
| EX. 16 | PVA-BASED | 2000 | 10% mass | HYDRAZIDE | LONG-CHAIN ALKYL ACRYLATE | WIRE BAR |
| | | | | DERIVATIVE | | |
| EX. 17 | PVA-BASED | 1800 | 10% mass | POLYAMIDE | LONG-CHAIN ALKYL ACRYLATE | CURTAIN |
| | | | | EPICHLOROHYDRIN | | |

| | | | | | |
|---|---|---|---|---|---|
| COMP. EX 1 | PVA-BASED | NA | NA | NA | WIRE BAR |
| COMP. EX. 2 | PVA-BASED | NA | NA | LONG-CHAIN ALKYL ACRYLATE | WIRE BAR |
| COMP. EX. 3 | NA | NA | POLYAMIDE | LONG-CHAIN ALKYL ACRYLATE | WIRE BAR |
| | | | EPICHLOROHYDRIN | | |
| COMP. EX. 4 | PVA-BASED | NA | NA | NA | CURTAIN |

TABLE 2
RESULTS

| | OIL | | RELEASABILITY | | PRINTER MATCHING | |
|---|---|---|---|---|---|---|
| | RESISTANCE | | [mN/40 mm] | | PRINTING NOISE [dB] | |
| | DATA | JUDGEMENT | DATA | JUDGEMENT | DATA | JUDGEMENT |
| EX. 1 | 1.06 | GOOD | 64 | FAIR | 95.2 | FAIR |
| EX. 2 | 1.03 | GOOD | 157 | VERY GOOD | 96.8 | FAIR |
| EX. 3 | 1.04 | GOOD | 182 | VERY GOOD | 95.7 | FAIR |
| EX. 4 | 1.03 | GOOD | 148 | VERY GOOD | 97.5 | FAIR |
| EX. 5 | 1.05 | GOOD | 124 | VERY GOOD | 93.7 | FAIR |
| EX. 6 | 1.06 | GOOD | 158 | VERY GOOD | 96.3 | FAIR |
| EX. 7 | 1.06 | GOOD | 172 | VERY GOOD | 98.4 | FAIR |
| EX. 8 | 1.02 | GOOD | 186 | VERY GOOD | 86.4 | GOOD |
| EX. 9 | 0.81 | FAIR | 225 | VERY GOOD | 90.3 | FAIR |
| EX. 10 | 1.18 | VERY GOOD | 261 | VERY GOOD | 89.4 | GOOD |
| EX. 11 | 1.13 | VERY GOOD | 288 | VERY GOOD | 85.4 | GOOD |
| EX. 12 | 1.09 | VERY GOOD | 114 | VERY GOOD | 91.2 | FAIR |
| EX. 13 | 1.31 | VERY GOOD | 374 | GOOD | 87.5 | GOOD |
| EX. 14 | 1.31 | VERY GOOD | 732 | FAIR | 88.4 | GOOD |
| EX. 15 | 1.15 | VERY GOOD | 275 | VERY GOOD | 83.4 | GOOD |
| EX. 16 | 1.16 | VERY GOOD | 285 | VERY GOOD | 85.3 | GOOD |
| EX. 17 | 1.14 | VERY GOOD | 253 | VERY GOOD | 74.5 | VERY GOOD |
| COMP. EX. 1 | 1.05 | GOOD | 5312 | POOR | 85.3 | GOOD |
| COMP. EX. 2 | 1.02 | GOOD | 1024 | POOR | 101.2 | POOR |
| COMP. EX. 3 | 0.24 | POOR | 642 | FAIR | 107.6 | POOR |
| COMP. EX. 4 | 1.06 | GOOD | 4954 | POOR | 73.9 | VERY GOOD |

It was confirmed that Examples 1 to 17 had the evaluation results of “Fair” or better in all of the oil resistance, releasability, and printer matching (conformability with the printer), and satisfied the usable conditions.

Moreover, it was found that the releasability tended to be slightly lower than the ideal releasability in Example 1 in which dimethylsilicone was used in the release layer. Therefore, it has been found that a non-silicone material, such as long-chain alkyl acrylate and silicone-modified acrylics, is preferably used in the release layer.

Further, in Examples 8 to 17, in which polyvinyl alcohol was added to the release layer, at least one of the evaluation results of oil resistance, releasability, and printer matching (conformability with the printer) was “Very good.” Thus, it has been found that the polyvinyl alcohol is preferably added to the release layer.

It was confirmed that the evaluation results of oil resistance and printer matching (conformability with the printer) in Example 9, in which the protective layer did not include polyvinyl alcohol, were less desirable as compared with Examples 8 and 10 to 17. Thus, it has been found that the polyvinyl alcohol is more preferably included in both the protective layer and the release layer.

Since the evaluation results of oil resistance, releasability, and printer matching (conformability with the printer) were all “Very good” in Example 17, in which the three layers, i.e., the thermosensitive layer, the protective layer, and the release layer, were simultaneously applied by the curtain coater, the quality of the thermosensitive recording medium was improved by applying the layers using the curtain coater. The improvement in the printer matching (conformability with the printer) is assumed to be attributed to the improvement in adhesion between the layers achieved by simultaneous multilayer curtain coating.

It was confirmed that at least one of the evaluation results of oil resistance, releasability, and printer matching (conformability with the printer) was “Poor” in Comparative Examples 1 to 4, and the results were less desirable as compared with a thermosensitive recording medium of the related art. In particular, in Comparative Examples 1 and 4, in which a release layer was not provided, the evaluation result of releasability was “Poor” regardless of the coating method. Moreover, the evaluation result of releasability was “Poor” in Comparative Example 3 in which a protective layer was not provided. Further, the evaluation results of releasability and printer matching (conformability with the printer) were both “Poor” in Comparative Example 2 because, although the protective layer and the release layer were provided, the release layer did not include any of epichlorohydrin, polyamide epichlorohydrin, an oxazoline derivative, hydrazine, or a hydrazide derivative.

Accordingly, it has been found that, since the release layer includes at least one selected from the group consisting of epichlorohydrin, polyamide epichlorohydrin, an oxazoline derivative, hydrazine, and a hydrazide derivative, oil resistance, releasability, and printer matching (conformability with a printer) are all improved.

The embodiments of the present disclosure include, for example, the following.

<1>

A thermosensitive recording medium for a linerless label includes a support, a thermosensitive recording layer, a protective layer, and a release layer, in which the release layer includes at least one selected from the group consisting of epichlorohydrin, polyamide epichlorohydrin, an oxazoline derivative, hydrazine, and a hydrazide derivative, and the thermosensitive recording layer, the protective layer, and the release layer are disposed on one side of the support.

<2>

In the thermosensitive recording medium according to <1>, the release layer further includes polyvinyl alcohol crosslinkable with at least one selected from the group consisting of epichlorohydrin, polyamide epichlorohydrin, an oxazoline derivative, hydrazine, and a hydrazide derivative.

<3>

In the thermosensitive recording medium according to <2>, the protective layer includes a polyvinyl alcohol that is the same polyvinyl alcohol as the polyvinyl alcohol of the release layer.

<4>

In the thermosensitive recording medium according to <2> or <3>, an amount of the polyvinyl alcohol included in the release layer is 0.5 percent by mass or greater and 30 percent by mass or less, relative to a total mass of the release layer.

<5>

In the thermosensitive recording medium according to any one of <2> to <4>, in which a degree of polymerization of the polyvinyl alcohol included in the release layer is 200 or greater and 2,500 or less.

<6>

In the thermosensitive recording medium according to any one of <1> to <5>, the release layer further includes at least one selected from the group consisting of a long-chain alkyl acrylate and a silicone-modified acrylic.

<7>

A method for producing the thermosensitive recording medium of any one of <1> to <6>, includes performing single-pass coating to form the thermosensitive recording layer, the protective layer, and the release layer on the support.

<8>

A method for producing the thermosensitive recording medium of any one of <1> to <6>, includes performing simultaneous multilayer curtain coating to form the thermosensitive recording layer, the protective layer, and the release layer on the support.

### REFERENCE SIGNS LIST

S sample
W width
L length
P pattern
D pitch

### CITATION LIST

### Patent Literature

[Patent Document 1] U.S. Pat. No. 10,550,293

1. A thermosensitive recording medium for a linerless label, the thermosensitive recording medium comprising:
a support;
a thermosensitive recording layer;
a protective layer; and
a release layer;
wherein the release layer includes at least one selected from the group consisting of an epichlorohydrin, a polyamide epichlorohydrin, an oxazoline derivative, a hydrazine, and a hydrazide derivative, and
wherein the thermosensitive recording layer, the protective layer, and the release layer are disposed on one side of the support.

2. The thermosensitive recording medium according to claim 1,
wherein the release layer further includes polyvinyl alcohol crosslinkable with at least one selected from the group consisting of an epichlorohydrin, a polyamide epichlorohydrin, an oxazoline derivative, a hydrazine, and a hydrazide derivative.

3. The thermosensitive recording medium according to claim 2,
wherein the protective layer includes a polyvinyl alcohol that is the same polyvinyl alcohol as the polyvinyl alcohol of the release layer.

4. The thermosensitive recording medium according to claim 2,
wherein an amount of the polyvinyl alcohol included in the release layer is 0.5 percent by mass or greater and 30 percent by mass or less, relative to a total mass of the release layer.

5. The thermosensitive recording medium according to claim 2,
wherein a degree of polymerization of the polyvinyl alcohol included in the release layer is 200 or greater and 2,500 or less.

6. The thermosensitive recording medium according to claim 1,
wherein the release layer further includes at least one selected from the group consisting of a long-chain alkyl acrylate and a silicone-modified acrylic.

7. A method for producing the thermosensitive recording medium of claim 1, the method comprising:
performing single-pass coating to form the thermosensitive recording layer, the protective layer, and the release layer on the support.

8. A method for producing the thermosensitive recording medium of claim 1, the method comprising:
performing simultaneous multilayer curtain coating to form the thermosensitive recording layer, the protective layer, and the release layer on the support.
